(19) United States
(12) Patent Application Publication
(10) Pub. No.: US 2026/0285160 A1
(43) Pub. Date: Sep. 24, 2026

(54) CONNECTING A REFUSE BODY TO A REFUSE COLLECTION VEHICLE

(71) Applicant: The Heil Co., Chattanooga, TN (US)

(72) Inventors: Tony Lawayne Coffey, Dawson, AL (US); Craig Allan Richards, Jasper, TN (US)

(21) Appl. No.: 19/576,089

(22) Filed: Mar. 24, 2026

Related U.S. Application Data
(60) Provisional application No. 63/776,697, filed on Mar. 24, 2025.

(51) Int. Cl. B60L 1/00; B65F 3/02; B65F 3/04; B65F 3/28

(52) U.S. Cl. CPC B60L 1/003; B65F 3/04; B65F 3/28; B60L 2200/40; B60L 2210/10; B60L 2250/10; B65F 2003/0283

(57) ABSTRACT

A refuse collection vehicle with a chassis with a vehicle controller, a refuse body mounted on the chassis, a chassis electrical power system, a refuse body electrical power subsystem, a connector to electrically connect and disconnect the chassis electrical power system and the refuse body electrical power subsystem, and a controller to operate the connector. The controller performs an electrical isolation test of the chassis electrical power system while the refuse body electrical power subsystem is disconnected from the chassis electrical power system; sends a signal to the vehicle controller indicating a result of the electrical isolation test; in response to the signal indicating an acceptable result of the electrical isolation test, electrically connecting the refuse body electrical power subsystem to the chassis electrical power system; and performs another electrical isolation test of the chassis electrical power system with the refuse body electrical power subsystem connected.

### CROSS-REFERENCE TO RELATED APPLICATION

This application claims the benefit under 35 U.S.C. § 119(e) of U.S. Patent Application No. 63/776,697, entitled “Connecting a Refuse Body to a Refuse Collection Vehicle,” filed Mar. 24, 2025, which is incorporated herein by reference in its entirety.

### TECHNICAL FIELD

This disclosure relates to the field of refuse collection vehicles.

### BACKGROUND

Refuse collection vehicles pick up quantities of refuse (e.g., garbage, waste, recyclables, and so on) for hauling to a designated area, such as a landfill, transfer station, or material recovery facility. These vehicles hold the refuse in a large refuse body which is a storage container supported on the vehicle chassis. Many refuse collection vehicles include onboard systems such as a lift arm that move customer refuse containers holding refuse to deposit the refuse into the refuse body and a packer that transfers refuse from an intake area (e.g., a hopper) of the refuse body into the storage container and compacts the refuse within the storage container. Some refuse bodies are electrically powered from the vehicle chassis. Sometimes, either or both of the refuse body and the vehicle chassis can have electrical faults, hindering or even preventing operation of the refuse body and the vehicle chassis.

### SUMMARY

Aspects of this disclosure are directed to vehicles, systems, and techniques that facilitate refuse collection, storage, and compaction.

In one aspect, a refuse collection vehicle includes a vehicle chassis, a refuse body physically mounted on the vehicle chassis, a connector, and a controller. The vehicle chassis includes a chassis electrical power system and a vehicle controller operatively coupled to the chassis electrical power system. The refuse body includes a refuse body electrical power subsystem. The connector is disposed between the chassis electrical power system and the refuse body electrical power subsystem. The connector is operable to electrically connect and disconnect the chassis electrical power system and the refuse body electrical power subsystem. The controller is operatively coupled to the connector. The controller performs operations including performing a first electrical isolation test of the chassis electrical power system while the refuse body electrical power subsystem is disconnected from the chassis electrical power system; sending a signal to the vehicle controller indicating a result of the first electrical isolation test; in response to the signal indicating an acceptable result of the first electrical isolation test, electrically connecting the refuse body electrical power subsystem to the chassis electrical power system; and performing a second electrical isolation test of the chassis electrical power system with the refuse body electrical power subsystem connected.

In another aspect combinable with any other aspect, the controller is positioned on the refuse body.

In another aspect combinable with any other aspect, the vehicle electrical power subsystem includes an DC/DC converter. The DC/DC converter powers a refuse handling component of the refuse body. The DC/DC converter is optionally coupled to the refuse body electrical power subsystem by the connector.

In another aspect combinable with any other aspect, the refuse handling component includes a lift arm to reposition a customer refuse container relative to the refuse body. The lift arm is powered by the DC/DC converter.

In another aspect combinable with any other aspect, the refuse handling component includes a packer to reposition the customer refuse within the refuse body. The packer is powered by the DC/DC converter.

In another aspect combinable with any other aspect, the refuse collection vehicle includes a controller area network coupled to the chassis electrical power system, the refuse body electrical power subsystem, the connector, and the controller.

In another aspect combinable with any other aspect, performing the first electrical isolation test of the chassis electrical power system includes commencing the first electrical isolation test responsive to a chassis ignition key transitioning to an ON state; determining a resistance of the chassis electrical power system; comparing the resistance of the chassis electrical power system to a threshold resistance for the chassis electrical power system; and based on the resistance of the chassis electrical power system greater than or equal to the threshold resistance, generating the signal indicating the acceptable result of the first electrical isolation test.

In another aspect combinable with any other aspect, the controller further performs operations including bypassing performing the first electrical isolation test of the chassis electrical power system when a time interval since operation of the refuse collection vehicle is less than a threshold time interval.

In another aspect combinable with any other aspect, the threshold time interval is twelve hours.

In another aspect combinable with any other aspect, the controller further performs operations including in response to the signal indicating an unacceptable result of the first electrical isolation test, shutting down the refuse body electrical power subsystem.

In another aspect combinable with any other aspect, the controller further performs operations including generating a user alert signal indicating the unacceptable result of the first electrical isolation test; and transmitting the user alert signal to a user accessible device.

In another aspect combinable with any other aspect, the controller further performs operations including after performing the second electrical isolation test of the chassis electrical power system with the refuse body electrical power subsystem connected, sending the signal to the controller of the refuse body electrical power subsystem indicating the result of the second electrical isolation test; and in response to the signal indicating the acceptable result of the second electrical isolation test, enabling operation of the chassis electrical power system with the refuse body electrical power subsystem.

In another aspect combinable with any other aspect, the controller further performs operations including in response to the signal indicating an unacceptable result of the second electrical isolation test, electrically disconnecting the refuse body electrical power subsystem from the chassis electrical power system; and responsive electrically disconnecting the refuse body electrical power subsystem from the chassis electrical power system, disabling operation of the refuse body electrical power subsystem.

In another aspect combinable with any other aspect, the controller further performs operations including during operation of the chassis electrical power system with the refuse body electrical power subsystem, performing a continuous electrical isolation test of the chassis electrical power system with the refuse body electrical power subsystem; sending the signal to the controller of the refuse body electrical power subsystem indicating the result of the first electrical isolation test; and in response to the signal indicating an acceptable result of the continuous electrical isolation test, maintaining the refuse body electrical power subsystem electrically connected to the chassis electrical power system.

In another aspect combinable with any other aspect, performing the continuous electrical isolation test of the chassis electrical power system with the refuse body electrical power subsystem includes comparing a resistance of the electrically connected chassis electrical power system and the refuse body electrical power subsystem to a threshold resistance for the electrically connected chassis electrical power system and the refuse body electrical power subsystem; and based on the resistance of the electrically connected chassis electrical power system and the refuse body electrical power subsystem greater than or equal to the threshold resistance for the electrically connected chassis electrical power system and the refuse body electrical power subsystem, generating the signal indicating an acceptable result of the continuous electrical isolation test.

In another aspect combinable with any other aspect, the controller further performs operations including after performing the continuous electrical isolation test of the chassis electrical power system with the refuse body electrical power subsystem connected, sending a signal to the controller of the refuse body electrical power subsystem indicating a result of the continuous electrical isolation test; and in response to the signal indicating an acceptable result of the continuous electrical isolation test, maintaining operation of the chassis electrical power system with the refuse body electrical power subsystem enabled.

In another aspect combinable with any other aspect, the controller further performs operations including in response to the signal indicating an unacceptable result of the continuous electrical isolation test, disconnecting the refuse body electrical power subsystem from the chassis electrical power system.

In another aspect combinable with any other aspect, the controller further performs operations including in response to the signal indicating an unacceptable result of the continuous electrical isolation test, generating a user alert signal indicating the unacceptable result of the first electrical isolation test; and transmitting the user alert signal to a user accessible device.

In another aspect combinable with any other aspect, the controller further performs operations including after disconnecting the refuse body electrical power subsystem from the chassis electrical power system, performing the first electrical isolation test on the chassis electrical power system.

In another aspect, a controller for an electrically powered refuse collection vehicle performs operations including performing a first electrical isolation test of a chassis electrical power system of the electrically powered refuse collection vehicle while a refuse body electrical power subsystem of the electrically powered refuse collection vehicle is disconnected from the chassis electrical power system; sending a signal to a vehicle controller of the electrically powered refuse collection vehicle indicating a result of the first electrical isolation test; in response to the signal indicating an acceptable result of the first electrical isolation test, electrically connecting the refuse body electrical power subsystem to the chassis electrical power system; and performing a second electrical isolation test of the chassis electrical power system with the refuse body electrical power subsystem connected.

In another aspect combinable with any other aspect, performing the first electrical isolation test of the chassis electrical power system includes commencing the first electrical isolation test responsive to a chassis ignition key transitioning to an ON state; determining a resistance of the chassis electrical power system; comparing the resistance of the chassis electrical power system to a threshold resistance for the chassis electrical power system; and based on the resistance of the chassis electrical power system greater than or equal to the threshold resistance, generating the signal indicating the acceptable result of the first electrical isolation test.

In another aspect combinable with any other aspect, the controller further performs operations including bypassing performing the first electrical isolation test of the chassis electrical power system when a time interval since operation of the electrically powered refuse collection vehicle is less than a threshold time interval.

In another aspect combinable with any other aspect, the threshold time interval is twelve hours.

In another aspect combinable with any other aspect, the controller performs further operations including in response to the signal indicating an unacceptable result of the first electrical isolation test, shutting down the refuse body electrical power subsystem.

In another aspect combinable with any other aspect, the controller performs further operations including generating a user alert signal indicating the unacceptable result of the first electrical isolation test; and transmitting the user alert signal to a user accessible device.

In another aspect combinable with any other aspect, the controller performs further operations including after performing the second electrical isolation test of the chassis electrical power system with the refuse body electrical power subsystem connected, sending the signal to the controller of the refuse body electrical power subsystem indicating the result of the second electrical isolation test; and in response to the signal indicating the acceptable result of the second electrical isolation test, enabling operation of the chassis electrical power system with the refuse body electrical power subsystem.

In another aspect combinable with any other aspect, the controller performs further operations including in response to the signal indicating an unacceptable result of the second electrical isolation test, electrically disconnecting the refuse body electrical power subsystem from the chassis electrical power system; and responsive electrically disconnecting the refuse body electrical power subsystem from the chassis electrical power system, disabling operation of the refuse body electrical power subsystem.

In another aspect combinable with any other aspect, the controller performs further operations including during operation of the chassis electrical power system with the refuse body electrical power subsystem, performing a continuous electrical isolation test of the chassis electrical power system with the refuse body electrical power subsystem; sending the signal to the controller of the refuse body electrical power subsystem indicating the result of the first electrical isolation test; and in response to the signal indicating an acceptable result of the continuous electrical isolation test, maintaining the refuse body electrical power subsystem electrically connected to the chassis electrical power system.

In another aspect combinable with any other aspect, performing the continuous electrical isolation test of the chassis electrical power system with the refuse body electrical power subsystem includes comparing a resistance of the electrically connected chassis electrical power system and the refuse body electrical power subsystem to a threshold resistance for the electrically connected chassis electrical power system and the refuse body electrical power subsystem; and based on the resistance of the electrically connected chassis electrical power system and the refuse body electrical power subsystem greater than or equal to the threshold resistance for the electrically connected chassis electrical power system and the refuse body electrical power subsystem, generating the signal indicating an acceptable result of the continuous electrical isolation test.

In another aspect combinable with any other aspect, the controller performs further operations including after performing the continuous electrical isolation test of the chassis electrical power system with the refuse body electrical power subsystem connected, sending a signal to the controller of the refuse body electrical power subsystem indicating a result of the continuous electrical isolation test; and in response to the signal indicating an acceptable result of the continuous electrical isolation test, maintaining operation of the chassis electrical power system with the refuse body electrical power subsystem enabled.

In another aspect combinable with any other aspect, the controller performs further operations including in response to the signal indicating an unacceptable result of the continuous electrical isolation test, disconnecting the refuse body electrical power subsystem from the chassis electrical power system.

In another aspect combinable with any other aspect, the controller performs further operations including in response to the signal indicating an unacceptable result of the continuous electrical isolation test, generating a user alert signal indicating the unacceptable result of the first electrical isolation test; and transmitting the user alert signal to a user accessible device.

In another aspect combinable with any other aspect, the controller performs further operations including after disconnecting the refuse body electrical power subsystem from the chassis electrical power system, performing the first electrical isolation test on the chassis electrical power system.

In another aspect, a method of confirming electrical isolation status of an electrical circuit of an electrically powered vehicle includes performing a first electrical isolation test of a chassis electrical power system of the electrical circuit while a body electrical power subsystem of the electrical circuit is disconnected from the chassis electrical power system; sending a signal to a controller of the body electrical power subsystem indicating a result of the first electrical isolation test; in response to the signal indicating an acceptable result of the first electrical isolation test, electrically connecting the body electrical power subsystem to the chassis electrical power system; and performing a second electrical isolation test of the chassis electrical power system with the body electrical power subsystem connected.

In another aspect combinable with any other aspect, confirming the electrical isolation status of the electrical circuit of the electrically powered vehicle includes commencing the first electrical isolation test responsive to a chassis ignition key transitioning to an ON state; determining a resistance of the chassis electrical power system; comparing the resistance of the chassis electrical power system to a threshold resistance for the chassis electrical power system; and based on the resistance of the chassis electrical power system greater than or equal to the threshold resistance, generating the signal indicating the acceptable result of the first electrical isolation test.

In another aspect combinable with any other aspect, confirming the electrical isolation status of the electrical circuit of the electrically powered vehicle includes bypassing performing the first electrical isolation test of the chassis electrical power system when a time interval since operation of the electrically powered vehicle is less than a threshold time interval.

In another aspect combinable with any other aspect, the threshold time interval is twelve hours.

In another aspect combinable with any other aspect, confirming the electrical isolation status of the electrical circuit of the electrically powered vehicle includes in response to the signal indicating an unacceptable result of the first electrical isolation test, shutting down the body electrical power subsystem.

In another aspect combinable with any other aspect, confirming the electrical isolation status of the electrical circuit of the electrically powered vehicle includes generating a user alert signal indicating the unacceptable result of the first electrical isolation test; and transmitting the user alert signal to a user accessible device.

In another aspect combinable with any other aspect, confirming the electrical isolation status of the electrical circuit of the electrically powered vehicle includes after performing the second electrical isolation test of the chassis electrical power system with the body electrical power subsystem connected, sending the signal to the controller of the body electrical power subsystem indicating the result of the second electrical isolation test; and in response to the signal indicating the acceptable result of the second electrical isolation test, enabling operation of the chassis electrical power system with the body electrical power subsystem.

In another aspect combinable with any other aspect, confirming the electrical isolation status of the electrical circuit of the electrically powered vehicle includes in response to the signal indicating an unacceptable result of the second electrical isolation test, electrically disconnecting the body electrical power subsystem from the chassis electrical power system; and responsive electrically disconnecting the body electrical power subsystem from the chassis electrical power system, disabling operation of the body electrical power subsystem.

In another aspect combinable with any other aspect, confirming the electrical isolation status of the electrical circuit of the electrically powered vehicle includes during operation of the chassis electrical power system with the body electrical power subsystem, performing a continuous electrical isolation test of the chassis electrical power system with the body electrical power subsystem; sending the signal to the controller of the body electrical power subsystem indicating the result of the first electrical isolation test; and in response to the signal indicating an acceptable result of the continuous electrical isolation test, maintaining the body electrical power subsystem electrically connected to the chassis electrical power system.

In another aspect combinable with any other aspect, performing the continuous electrical isolation test of the chassis electrical power system with the body electrical power subsystem includes comparing a resistance of the electrically connected chassis electrical power system and the body electrical power subsystem to a threshold resistance for the electrically connected chassis electrical power system and the body electrical power subsystem; and based on the resistance of the electrically connected chassis electrical power system and the body electrical power subsystem greater than or equal to the threshold resistance for the electrically connected chassis electrical power system and the body electrical power subsystem, generating the signal indicating an acceptable result of the continuous electrical isolation test.

In another aspect combinable with any other aspect, confirming the electrical isolation status of the electrical circuit of the electrically powered vehicle includes after performing the continuous electrical isolation test of the chassis electrical power system with the body electrical power subsystem connected, sending a signal to the controller of the body electrical power subsystem indicating a result of the continuous electrical isolation test; and in response to the signal indicating an acceptable result of the continuous electrical isolation test, maintaining operation of the chassis electrical power system with the body electrical power subsystem enabled.

In another aspect combinable with any other aspect, confirming the electrical isolation status of the electrical circuit of the electrically powered vehicle includes in response to the signal indicating an unacceptable result of the continuous electrical isolation test, disconnecting the body electrical power subsystem from the chassis electrical power system.

In another aspect combinable with any other aspect, confirming the electrical isolation status of the electrical circuit of the electrically powered vehicle includes in response to the signal indicating an unacceptable result of the continuous electrical isolation test, generating a user alert signal indicating the unacceptable result of the first electrical isolation test; and transmitting the user alert signal to a user accessible device.

In another aspect combinable with any other aspect, confirming the electrical isolation status of the electrical circuit of the electrically powered vehicle includes after disconnecting the body electrical power subsystem from the chassis electrical power system, performing the first electrical isolation test on the chassis electrical power system.

Particular implementations of the subject matter described in this specification can be implemented so as to realize one or more material advantages. For example, providing automated techniques for detecting electrical anomalies and faults affecting the vehicle chassis and the refuse body may [i] prevent or reduce the likelihood of vehicle chassis and refuse body damage from faulty high voltage electrical systems; [ii] alleviate operators from the burden of manually monitoring electrical power system parameters; [iii] detect such anomalies and faults more quickly when they are easier to resolve; [iv] increase operational efficiency and energy efficiency by promoting optimal refuse body and vehicle chassis operations; and improve operator and customer safety by placing the refuse body and the vehicle chassis in a safe state when a fault exists.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 is a side view of a side-loading refuse collection vehicle featuring various aspects of the present disclosure.

FIG. 2 is a top view of the vehicle of FIG. 1 with a portion of the refuse collecting body hidden to show the internal storage volume of the storage container.

FIG. 3 is an enlarged portion of the top view of FIG. 2.

FIG. 4 is a schematic view of a communication network of the vehicle of FIG. 1.

FIG. 5 is a schematic view of the pre-charge circuit of the communication network of FIG. 4.

FIG. 6 is a schematic view of a controller of the communication network of FIG. 4.

FIG. 7 is a flow chart of a method of the confirming electrical isolation status of an electrical circuit of an electrically powered vehicle.

FIG. 8 is a flow chart of a power-up sequence.

FIG. 9 is a flow chart of a power-down sequence.

FIG. 10 is a flow chart of a runtime isolation test sequence.

### DETAILED DESCRIPTION

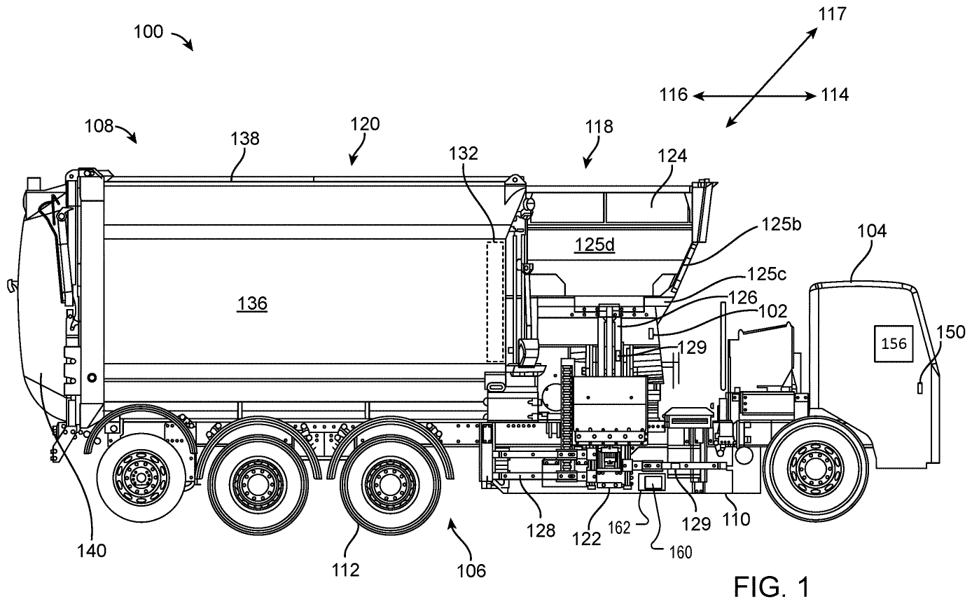

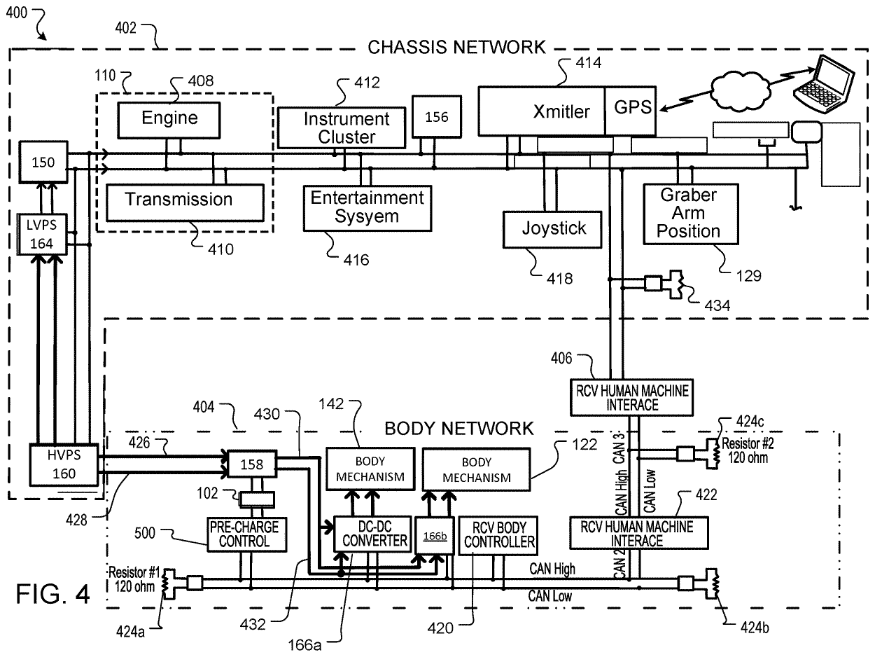

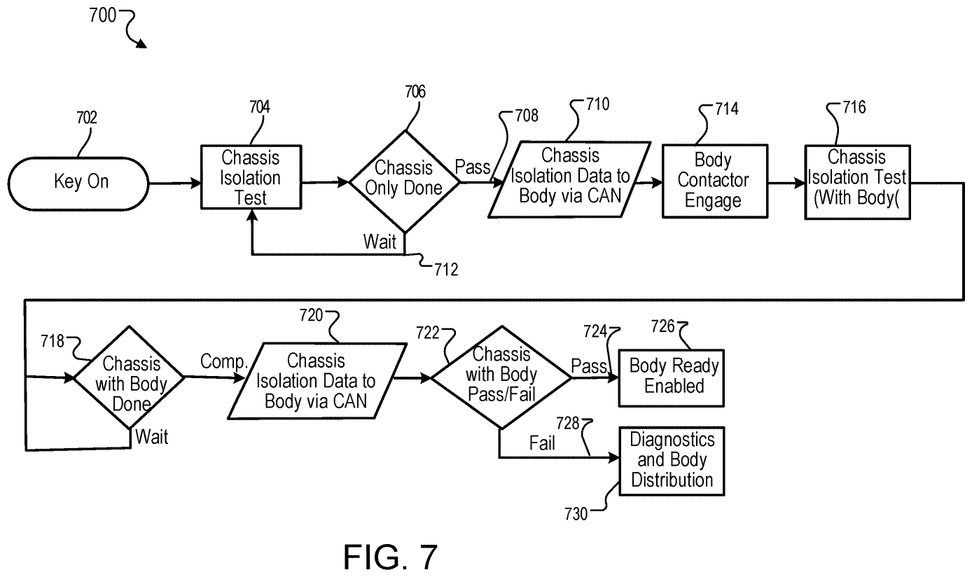

FIGS. 1-3 depict a vehicle 100 for collecting, packing, and transporting refuse (e.g., garbage, waste, recyclables, and so on) to a designated area, such as a landfill, transfer station, or material recovery facility. The vehicle 100 has a chassis 106 and a refuse collecting body 108. The refuse collecting body 108 is mounted on the chassis 106. The chassis 106 and the refuse collecting body 108 are electrically powered. The chassis 106 supplies electrical power to the refuse collecting body 108. Sometimes one or both of the chassis 106 and the collecting body 108 can have an electrical fault, hindering or even preventing operation of either or both the chassis 106 and the collecting body 108. The vehicle 100 has an electrical isolation controller 102 to detect ground fault isolations the chassis 106 and the refuse collecting body 108 to alert the operator to the ground fault condition and affect the operation of the chassis 106 and the refuse collecting body 108 depending on the severity of the ground fault and the present state of the vehicle 100. For example, as described in more detail below, the electrical isolation controller 102 performs start-up checks to prevent electrically coupling the refuse collecting body 108 to the chassis 106 when a ground fault is detected. In some implementations, the electrical isolation controller 102 also continually monitors the chassis 106 and the refuse collecting body 108 during operation for a ground fault. The controller area network 400 (shown in FIG. 4) that the electrical isolation controller 102 uses to communicate with and control operations of the chassis 106 and the refuse collecting body 108 is shown in FIG. 4. The processes performed by the electrical isolation controller 102 to electrically protect the chassis 106 and the refuse collecting body 108 are shown in FIGS. 7-10.

Referring to FIGS. 1-3 the refuse collection vehicle 100 can be called a garbage collection vehicle or garbage truck. The vehicle 100 includes a cab 104, a chassis 106, a refuse collecting body 108, and the electrical isolation controller 102. The cab 104 includes a compartment for a driver of vehicle 100. The compartment is equipped with controls that enable the driver to operate various elements of the chassis 106 and the body 108 and one or more displays that enable the driver to monitor such elements. The chassis 106 includes a power train 110 (e.g., an electric power train or a hybrid power train such as a fuel cell). The power train 110, which includes a prime mover (the chassis electrical power system 146) and a drivetrain (transmission), converts and transfers motive power to the wheels 112 that move the vehicle 100 on a road surface along a forward direction of travel 114 and a rearward direction of travel 116. The direction across the vehicle 100 and orthogonal to the forward/rearward directions is a transverse direction 117.

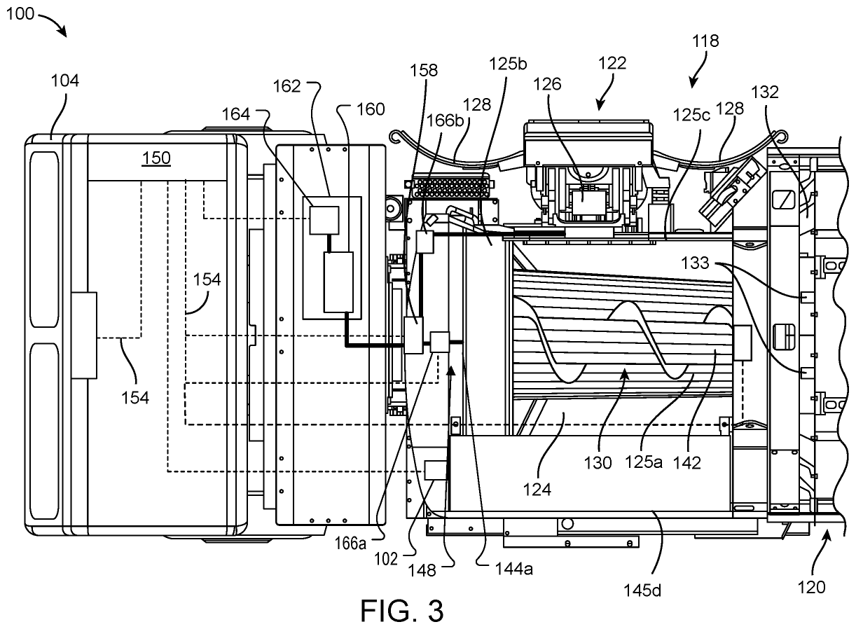

The refuse collecting body 108 includes an intake system 118, a storage container 120, a packer 130, an ejector 132, and a tailgate 140. The intake system 118 includes a lift 122 and a hopper 124. As discussed below, one or more components of the intake system 118, the storage container 120, the packer 130, the ejector 132, and the tailgate 140 are controlled by an onboard computing system including a controller 150 (i.e., a body controller 150) shown in FIGS. 3-5.

The lift 122 is operable to transfer the contents of residential refuse containers into the storage container 120 via the hopper 124. In this example, the lift 122 includes a side-loading arm assembly including a reach (not shown), a mast 126, and a grabber 128 with grabber arms 123. During use, when vehicle 100 pulls up to a residential refuse container, the lift 122 performs a dump-cycle “service event” that includes: (i) moving the grabber 128 in the transverse direction away from the vehicle and toward the container via the reach; (ii) engaging (e.g., grasping) the container with the grabber 128; (iii) moving the grabber 128 with the container back toward the vehicle via the reach; (iv) raising the grabber 128 and the container vertically along the mast 126; and (v) dumping the contents of the container into the hopper 124. A set of one or more lift sensors 129 monitor operation of the lift 122 during the dump cycle.

The storage container 120 provides a refuse storage volume defined (at least in part) by a floor 134, lateral side walls 136, and a cover 138. The ejector 132 features a movable panel that provides a front wall of the storage volume, separating the storage container 120 from the hopper 124. The tailgate 140 provides the storage volume's rear wall.

The hopper 124 is located forward of the storage container 120. The hopper 124 provides a refuse intake volume defined (at least in part) by a floor 125a, a front wall 125b facing cab 104, a loading-side wall 125c facing lift 122, an opposite port-side wall 125d, and the movable panel of ejector 132. When lift 122 performs a dump cycle, the grabber 128 and the refuse container it holds are raised and at least partially upended over the loading-side wall 125c to deposit the container's contents into the intake volume of hopper 124.

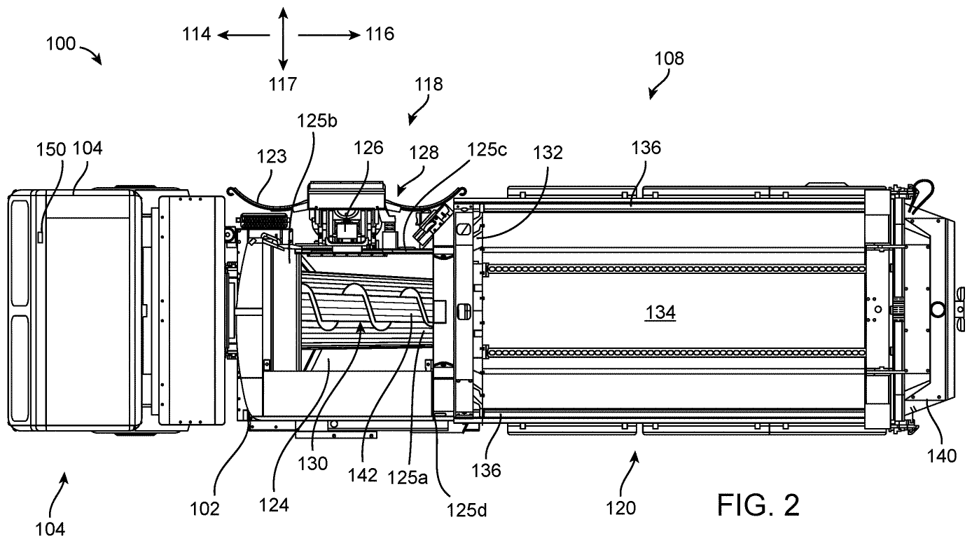

In one exemplary (but non-limiting) use-case, the vehicle 100 traverses a refuse collection route including numerous (e.g., hundreds) service stops to pick up residential refuse containers, dump waste into the hopper 124, transfer waste from the hopper 124 into the storage container 120, and compact the waste within the storage container 120. After completing all or part of a collection route, vehicle 100 travels to a designated area and ejects the waste from the storage container 120 using the ejector 132. To eject a load of waste, tailgate 140 pivots from a closed position (as shown in FIGS. 1-2) to an open position, and the panel of ejector 132 moves rearward, pushing the load through the tailgate opening (an “eject event”). A set of one or more ejector sensors 133 monitor operation of ejector 132 during such an ejection event.

These lifting, dumping, and ejecting operations performed by the refuse collecting body 108 are powered by a chassis electrical power system 146 and controlled by the body controller 150 in cooperation with a refuse body electrical power subsystem 148 and the electrical isolation controller 102. The vehicle 100 includes a connector 158 which alternatively electrically connects and disconnects the chassis electrical power system 146 from the refuse body electrical power subsystem 148 so the chassis electrical power system 146 can supply electrical power to the refuse body electrical power subsystem 148 to operate components of the refuse collecting body 108. By electrically connecting and disconnecting, we refer to the completion and interruption of a power circuit coupling the chassis and body electrical power systems to enable and disable, respectively, electrical power transfer between those systems. This may be accomplished by actively connecting and disconnecting a positive power lead, for example, while leaving both systems connected to a common ground. Alternatively, both power and ground connections of a high voltage power circuit can be coupled/uncoupled by opening and closing connector 158.

The body controller 150 controls operation on components, systems, and subsystems of the chassis 106. The body controller 150 also controls operations of the connector 158. The electrical isolation controller 102 monitors and performs start-up checks by checking the resistance of the refuse collecting body 108 and the chassis 106 before electrically connecting the chassis 106 to the refuse collecting body 108. This protects the refuse collecting body 108. The electrical isolation controller 102 also monitors the chassis 106 and the refuse collecting body 108 while electrically connected during operation of the vehicle 100 to collect customer refuse to detect a ground fault. The electrical isolation controller 102 sends signals to the controller 150 via the controller area network 400 to allow the body controller 150 to close the connector 158, electrically coupling the chassis 106 to the refuse collecting body 108, as described in reference to FIGS. 7-10.

The power train 110 includes the chassis electrical power system 146. The chassis electrical power 146 provides electrical power to components of the chassis 106 and refuse collecting body 108. The chassis electrical power system 146 can include an electrical storage device 160 to generate and/or store an electrical charge and supply electrical power to the components of the chassis 106 and the refuse collecting body 108. In this example, the electrical storage device 160 is a battery. In other implementations, the electrical storage device 160 can be a fuel cell, capacitor, super-capacitor, or a regeneration system.

The chassis electrical power system 146 is a high voltage direct current supply system 162. In this implementation, a typical high voltage range is between 400-850 volts DC (VDC). In other implementations, the maximum voltage can be 1000 VDC, 1200 VDC, or even 1500 VDC. The chassis electrical power system 146 may have any suitable high voltage range. The chassis electrical power system 146 supplies the high voltage electrical power from the electrical storage device 160 through the connector 158 to the refuse body electrical power subsystem 148.

The chassis electrical power system 146 also includes a low voltage direct current supply system 164 to supply electrical power to the electrical isolation controller 102, the controller 150, the controller area network 400, and the other control systems of the vehicle 100. The low voltage direct current supply system 164 receives electrical power from the high voltage direct current supply system 162 and converts the high voltage to a lower voltage which can be supplied to the control components and electronics of the chassis 106 via an appropriately fused wiring system and to components of the refuse collecting body 108 via similarly fused wiring connections.

The low voltage system is typically at a voltage of between 12-140 VDC with a maximum current of the low voltage direct current supply system 164 of approximately 70 amps (A).

In this example, the electrical isolation controller 102 and the connector 158 are physically mounted on the refuse collecting body 108, but in other examples may be physically mounted on the chassis.

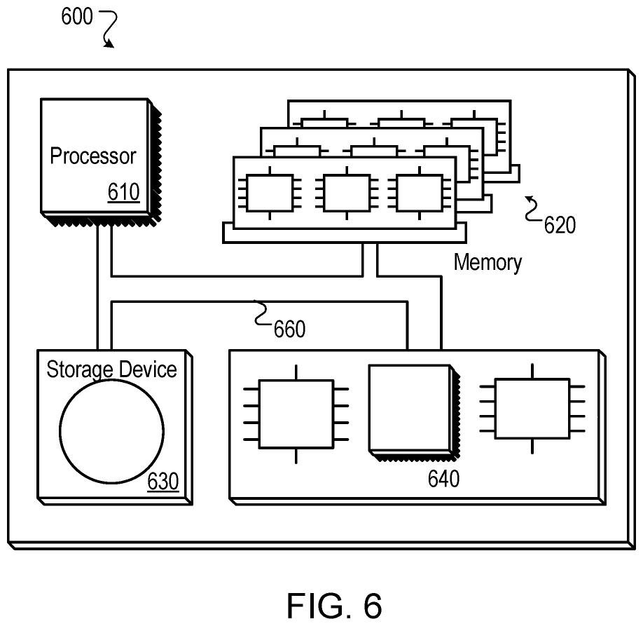

The controller 150 is an under-dash device (UDU) and may also be called the Gateway. The controller 150 includes a programmable logic controller (PLC) with integral data input/output, memory, and processing components, for example, the computing system 600 shown and described in reference to FIG. 6. The information network 154 includes an onboard wired data bus. The controller 150 issues command signals through the information network 154 that cause an auger drive DC/DC converter 166a to rotate the auger 142. The command signals from the controller 150 may dictate the direction and speed of rotation. The command signals may also the cause auger drive DC/DC converter 166a to cease rotating. The controller 150 issues command signals through the information network 154 that causes the lift 122 to raise, lower, tilt, rotate, engage, and disengage the customer refuse container.

The controller 150 performs control schemes and issues control commands based on hopper condition data, packer load data received, and the lift 122 via information network 154 to the packer 130 and the lift 122. The controller 150 also provides, via the information network 154, information (e.g., data, alerts, and so on) regarding the operation of the refuse collecting body 108 to a user interface system 156 viewable by a human operator in the vehicle's cab 104.

When the connector 158 is open, the refuse body electrical power subsystem 148 is disconnected from the chassis electrical power system 146 and no high voltage electrical power can flow from the chassis electrical power system 146 to the refuse body electrical power subsystem 148. When the connector 158 is closed, the refuse body electrical power subsystem 148 is connected to the chassis electrical power system 146 and high voltage electrical power can flow from the chassis electrical power system 146 to the refuse body electrical power subsystem 148.

The refuse body electrical power subsystem 148 includes one or more DC-DC converters 166a, 166b (shown in FIGS. 3-4). The DC-DC converters 166a, 166b alter the DC voltage of the electrical power from the chassis electrical power system 146 to allow for independent control of motor relays and actuators for the various body 108 components so the body components function within prescribed engineering limits. The DC-DC converters 166a, 166b supply the electrical power at the converted voltage, for example, to the auger 142 and the lift 122.

FIG. 4 shows the controller area network 400. The controller area network 400 is one implementation of information network 154. The controller 150 and the electrical isolation controller 102 use the controller area network 400 to receive and send information and command signals between vehicle components. In this implementation, the controller area network 400 uses the SAE J1939 Communication Protocol to standardize electronic communication between vehicle components.

The J1939 protocol uses Parameter Group Numbers (PGNs) which are each associated with eight bytes of data which are normally broken into a suspect parameter number groups (SPNs). Maps of the SPNs can be provided by the manufacturer or industry standard organization that identify set of numbers that correspond to particular sets of information relative to the vehicle 100.

For hypothetical example purposes only, Parameter Group No. 1234 could relate to engine information such as RPM, oil pressure, and oil temperature, broken up into values within the eight bytes of data associated with that PGN as SPNs at specific locations in that order of eight bytes. Within the J1939 communication protocol, there are standard PGNs and proprietary PGNs. The standard PGNs range from 000000 to 00FEFF. The proprietary PGNs range from 00FF00 to 00FFFF.

The controller area network 400 transfers signals representing the status of the various components in the chassis 106 and the refuse collecting body 108 to the electrical isolation controller 102 and the controller 150. The electrical isolation controller 102 and the controller 150 send command signals via the controller area network 400 to operate the chassis 106 and the refuse collecting body 108.

The controller area network 400 has a chassis network 402 and a refuse body network 404. A chassis interface connector 406 couples the chassis network 402 to the body network 404. In this implementation, the chassis interface connector 406 is a RP170 connector, however, any other suitable connector may for the chassis interface connector 406. The controller 150 sends control signals to the refuse body 108 and receives status signals from the refuse collecting body 108 through the chassis interface connector 406.

The chassis network 402 is connected to the power train 110 (the engine 408 and the transmission 410), the vehicle instruments 412 in the cab 104, communications devices 414, the entertainment system 416, a joystick 418 to operate the lift 122, and sensors 129 to identify the lift 122 and grabber 128 position. The chassis network 402 receives status signals from the engine 408, the transmission 410, the vehicle instruments 412, the communications devices 414, the entertainment system 416, the joystick 418, and the sensors 129. The chassis network 402 transmits control signals to the engine 408, the transmission 410, and the communications devices 414. The chassis network 402 transmits command signals from the joystick 418 to the lift 122. The chassis network 402 can transmit command signals from any user input to any operable component of the vehicle 100.

The chassis network 402 is electrically coupled to the low voltage direct current supply system 164. The chassis network 402 receives low voltage electrical power from the low voltage direct current supply system 164 via the controller 150.

The refuse body network 404 sends status signals to the controller 150 and receives command signals from the controller 150 via the chassis network 402. The refuse body network 404 is electronically coupled to the to send and receive status signals between components and command signals from the controller 150 and the electrical isolation controller 102 to operate refuse collecting body 108 components.

The refuse body network 404 is coupled to the chassis network 402 by the chassis interface connector 406. The refuse body network 404 is electronically connected to the connector 158, the electrical isolation controller 102, the DC-DC converters 166a, 166b, a refuse body controller 420, and a refuse body human machine interface 422. The chassis electrical power system 146 and the DC-DC converter 166b are also connected to the refuse body network 404, but not shown in FIG. 4 for clarity. The refuse body controller 420 runs the refuse body's 108 mechanical functions, controls the power generation of the body voltage vs the isolation check, and isolates electrical shorts to ground. The refuse body human machine interface 422 located in the cab 104 of the vehicle 100 in view of and in reach of the operator. The operator operates the refuse body human machine interface 422 independently from but with data from the chassis control system. The refuse body network 404 monitors and uses SPNs to perform the ground fault isolation checks and vehicle 100 operations as described in reference to FIGS. 7-10.

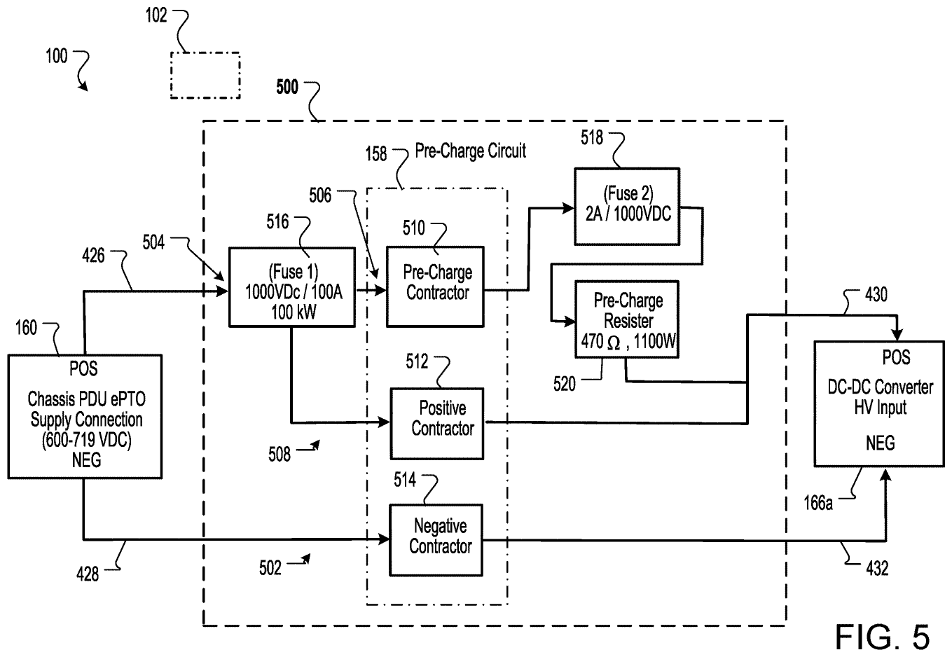

Referring to FIGS. 4-5, the electrical isolation controller 102 interfaces with a pre-charge circuit 500 to control electric coupling of the chassis 106 to the refuse collecting body 108. The pre-charge circuit 500 controls the connector 158 positioned between the electrical storage device 160 in the chassis 106 and the DC-DC converter 166a on the refuse collecting body 108. In some cases, the electrical isolation controller 102 includes the pre-charge circuit 500. The pre-charge circuit 500 operates the connector 158 to apply a voltage lower than the operating voltage to the DC-DC converter 166a to reduce harmful electrical transients and control the inrush of electrical current to the refuse body electrical power subsystem 148 during power-up or initialization. In this implementation, the electrical voltage supplied from the electrical storage device 160 to the DC-DC converter 166a for pre-charge operations is between 610-710 VDC and a maximum pre-charge current is 1.6 amps (A). In other implementations, any suitable pre-charge voltage and current may be used. A typical voltage range for the electrical storage device 160 is between 400-850 VDC with a maximum current of approximately 70 amps.

The electrical storage device 160 has a positive output 426 and a negative output 428 to supply the voltage to the connector 158. The DC-DC converters 166a has a positive input 430 and a negative input 432 to receive electrical power from the connector 158.

Referring to FIG. 5, the pre-charge circuit 500 has a negative branch 502 and a positive branch 504 with a pre-charge voltage section 506 and an operating voltage section 508. The connector 158 has a pre-charge contactor 510 positioned in the pre-charge voltage section 506, a positive contactor 512 positioned in the operating voltage section 508, and a negative contactor 514 positioned in the negative branch 502. The body controller 150, in coordination with the electrical isolation controller 102 performing the isolation checks, opens and closes the pre-charge contactor 510, the positive contactor 512, and the negative contactor 514 to control the flow of electrical power from the electrical storage device 160 to the DC-DC converter 166a based on the process described in reference to FIGS. 7-10.

The pre-charge circuit 500 includes a first fuse 516, a second fuse 518, and a pre-charge resistor 520. The first fuse 516 is positioned in the pre-charge voltage section 506 before the pre-charge voltage section 506 and the operating voltage section 508, upstream from the connector 158. In this implementation, the first fuse 516 is a 1000 VDC, 100 A, 100 kilowatt (kW) fuse. In other implementations, the first fuse 516 can be any suitable fuse. The second fuse 518 and the pre-charge resistor 520 are positioned in the pre-charge voltage section 506 downstream from the pre-charge contactor 510. In this implementation, the second fuse 518 is a 2 A, 1000 VDC fuse. In other implementations, the second fuse 518 can be any suitable fuse. In this implementation, the pre-charge resistor 520 is a 470 ohm, 1 kW resistor. In other implementations, the pre-charge resistor 520 can be any suitable resistor.

Referring to FIG. 6, the controller 150 and the electrical isolation controller 102, control units, and/or computing devices described throughout this disclosure can include or employ one or more computing systems 600. Computing system 600 may be used for any of the operations or functions described in this disclosure with reference to a computing device. For example, the system 600 may be included, in part, in controller 150 and/or any other computing device(s) or system(s) associated with the refuse collection vehicle 100. The system 600 includes one or more processors 610, a memory 620, one or more storage devices 630, and one or more input/output (I/O) devices controllable via one or more I/O interfaces 640. The various components 610, 620, 630, or 640 may be interconnected via at least one system bus 660, which may enable the transfer of data between the various modules and components of the system 600.

The system bus 660 may include a series of wired or wireless connections. In some embodiments, the system bus includes a CAN network bus operating under the J1939 protocol.

The processors 610 may be configured to process instructions for execution within the system 600. The processors 610 may include single-threaded processor(s), multi-threaded processors, or both. The processors 610 may process instructions stored in the memory 620 or on the storage devices 630. For example, the processor(s) 610 may execute instructions for the various software module(s) described here. The processor(s) 610 may include hardware-based processor(s) each including one or more cores. The processor(s) 610 may include general purpose processor(s), special purpose processor(s), or both.

The memory 620 may store information within the system 600. In some embodiments, the memory 620 includes one or more computer-readable media. The memory 620 may include any number of volatile memory units, any number of non-volatile memory units, or both volatile and non-volatile memory units. The memory 620 may include read-only memory, random access memory, or both. In some examples, the memory 620 may be employed as active or physical memory by one or more executing software modules.

The storage device(s) 630 may be configured to provide (e.g., persistent) mass storage for the system 600. In some embodiments, the storage device(s) 630 may include one or more computer-readable media. For example, the storage device(s) 630 may include a floppy disk device, a hard disk device, an optical disk device, or a tape device. The storage device(s) 630 may include read-only memory, random access memory, or both. The storage device(s) 630 may include one or more of an internal hard drive, an external hard drive, or a removable drive.

One or both of the memory 620 or the storage device(s) 630 may include one or more computer-readable storage media (CRSM). The CRSM may include one or more of an electronic storage medium, a magnetic storage medium, an optical storage medium, a magneto-optical storage medium, a quantum storage medium, or a mechanical computer storage medium. The CRSM may provide storage of computer-readable instructions describing data structures, processes, applications, programs, other modules, or other data for the operation of the system 600. In some embodiments, the CRSM may include a data store that provides storage of computer-readable instructions or other information in a non-transitory format. The CRSM may be incorporated into the system 600 or may be external with respect to the system 600. The CRSM may include read-only memory, random access memory, or both. One or more CRSM suitable for tangibly embodying computer program instructions and data may include any type of non-volatile memory, including, but not limited to, semiconductor memory devices, such as EPROM, EEPROM, DRAM, and flash memory devices; magnetic disks such as internal hard disks and removable disks; magneto-optical disks; and CD-ROM and DVD-ROM disks. In some examples, the processor(s) 610 and the memory 620 may be supplemented by, or incorporated into, one or more application-specific integrated circuits (ASICs).

The system 600 may include one or more I/O devices (not shown). The I/O device(s) may include one or more input devices such as a joystick, keypad, keyboard, a mouse, a pen, a game controller, a touch input device (e.g., a touch pad), an audio input device (e.g., a microphone), a gestural input device, a haptic input device, an image or video capture device (e.g., a camera), a mobile device, or other devices. In some examples, the I/O device(s) may also include one or more output devices such as a display, LED(s), an audio output device (e.g., a speaker), a printer, a haptic output device, and so forth. The I/O device(s) may be physically incorporated in one or more computing devices of the system 600 or may be external with respect to one or more computing devices of the system 600.

The system 600 may include one or more I/O interfaces 640 to enable components or modules of the system 600 to control, interface with, or otherwise communicate with the I/O device(s). The I/O interface(s) 640 may enable information to be transferred in or out of the system 600, or between components of the system 600, through serial communication, parallel communication, or other types of communication. For example, the I/O interface(s) 640 may comply with a version of the RS-232 standard for serial ports, or with a version of the IEEE 1284 standard for parallel ports. As another example, the I/O interface(s) 640 may be configured to provide a connection over Universal Serial Bus (USB) or Ethernet. In some examples, the I/O interface(s) 640 may be configured to provide a serial connection that is compliant with a version of the IEEE 1394 standard.

The I/O interface(s) 640 may also include one or more network interfaces that enable communications between computing devices in the system 600, or between the system 600 and other network-connected computing systems. The network interface(s) may include one or more network interface controllers (NICs) or other types of transceiver devices configured to send and receive communications over one or more communication networks using any network protocol.

Computing devices of the system 600 may communicate with one another, or with other computing devices, using one or more communication networks. Such communication networks may include public networks such as the internet, private networks such as an institutional or personal intranet, or any combination of private and public networks. The communication networks may include any type of wired or wireless network, including, but not limited to, local area networks (LANs), wide area networks (WANs), wireless WANs (WWANs), wireless LANs (WLANs), mobile communications networks (e.g., 3G, 4G, Edge, etc.), or a controller area network 400 (CAN) of the refuse collection vehicle 100. The controller area network 400 is described in more detail in reference to FIG. 4.

In some embodiments, the communications between computing devices may be encrypted or otherwise secured. For example, communications may employ one or more public or private cryptographic keys, ciphers, digital certificates, or other credentials supported by a security protocol, such as any version of the Secure Sockets Layer (SSL) or the Transport Layer Security (TLS) protocol.

The system 600 may include any number of computing devices of any type. The computing device(s) may include, but are not limited to a personal computer, a smartphone, a tablet computer, a wearable computer, an implanted computer, an automotive computer, a desktop computer, a laptop computer, a notebook computer, a microcomputer, a system on a chip (SoC), a system in a package (SiP). Although examples herein may describe computing device(s) as physical device(s), embodiments are not so limited. In some examples, a computing device may include one or more of a virtual computing environment, a hypervisor, an emulation, or a virtual machine executing on one or more physical computing devices. In some examples, two or more computing devices may include or access a cluster, cloud, farm, or other grouping of multiple devices that coordinate operations to provide load balancing, failover support, parallel processing capabilities, shared storage resources, shared networking capabilities, or other aspects.

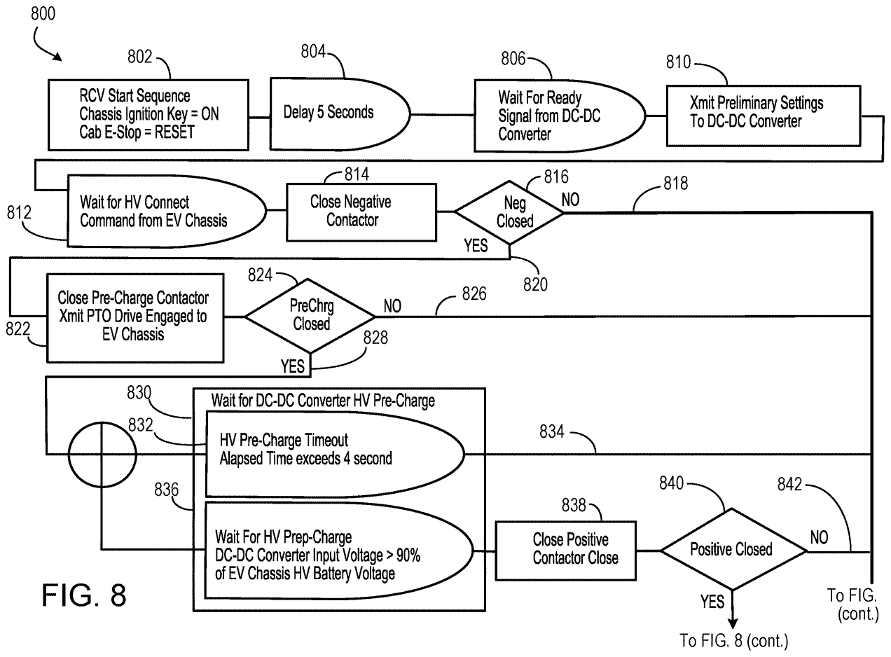

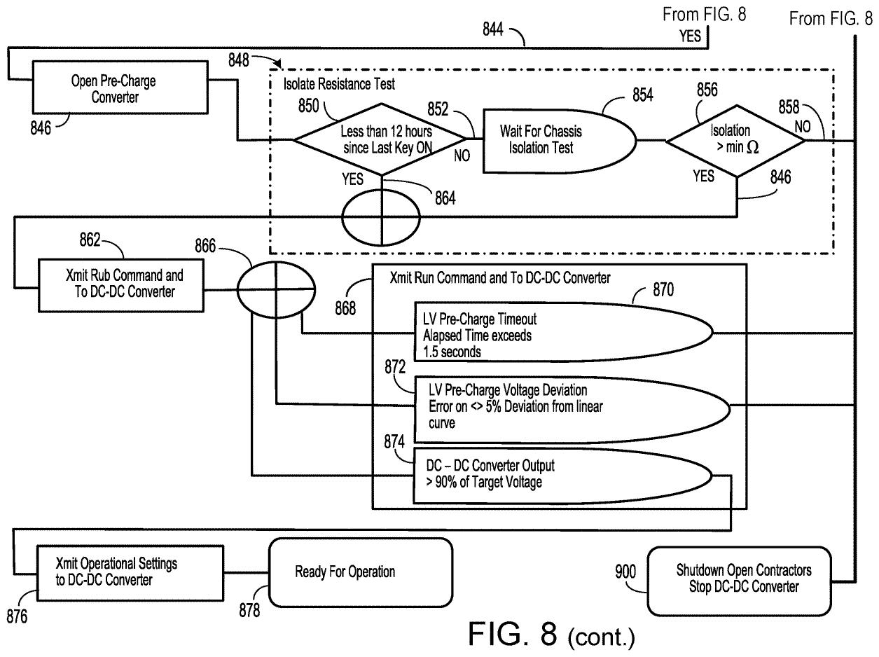

FIG. 7 is a flow chart of a method of confirming electrical isolation status of an electrical circuit of an electrically powered vehicle. FIG. 7 describes the overall approach described in more detail in reference to FIG. 8. FIG. 8 is a flow chart of the power-up sequence 800 performed by the controller 150 and the electrical isolation controller 102.

Referring to FIG. 7, an operator desires to collect refuse using the refuse collection vehicle 100. The refuse collection vehicle 100 is powered off, the chassis 106 is electrically disconnected from the refuse collecting body 108 (the connector 158 is open), and the refuse collection mechanisms such as the lift 122 is stowed. At 702, the operator turns the key in the ignition of the chassis 106 from the OFF position to the ON position.

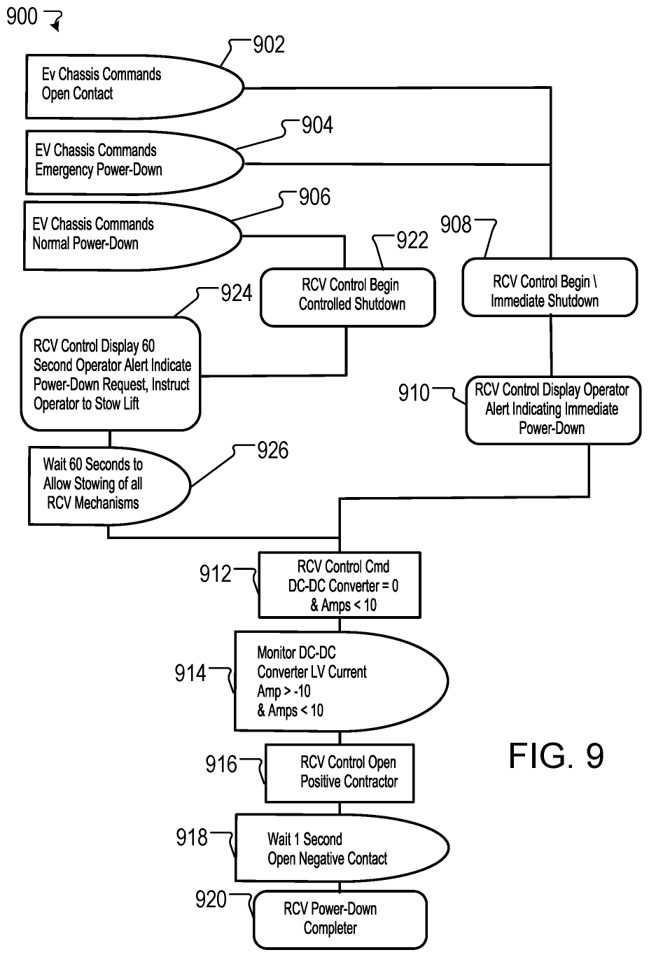

At 704, responsive to the key being placed in the ON position, the chassis isolation test is performed. For example, the electrical isolation controller 102 checks the resistance on the chassis 106. The electrical isolation controller 102 detects a chassis resistance. The electrical isolation controller 102 compares the detected chassis resistance to a chassis threshold resistance. At 706, the chassis isolation test is completed. At 708, when the detected chassis resistance is greater than or equal to the chassis threshold resistance, the electrical isolation controller 102 determines that no shorts or ground faults exist in the chassis 106 and at 708 a signal representing a PASS condition is generated. The process proceeds to 710. Returning to 706, when the detected chassis resistance is less than the chassis threshold resistance, the electrical isolation controller 102 determines that a short or ground fault exists in the chassis 106 at 712 a signal representing a WAIT condition is generated. This can be chassis isolation fail condition. The process returns to the 704 and the chassis isolation test can resume. The operator is alerted to the chassis isolation failed condition. In some cases, instead of resuming the chassis isolation test, the operator may return the key from the ON position to the OFF position. Further electrical tests can be conducted by the controller 150 or the operator to determine location of the ground fault. Or, if the operator fails to perform any action, the controller 150 can next perform the power-down sequence described in reference to FIG. 9.

Returning to 710, the signal representing the PASS condition is generated. The signal representing the PASS condition is transmitted from the electrical isolation controller 102 to the controller 150 along the controller area network 400.

At 714, based on the received signal representing the PASS condition from the electrical isolation controller 102, the controller 150 generates a control signal commanding the connector 158 to shut, and the connector 158 shuts. As described in more detail in reference to FIG. 8, shutting the connector 158 can include operating the pre-charge circuit 500.

After the connector 158 is shut, at 716 the electrically combined chassis 106 and refuse collecting body 108 are tested for shorts or ground faults. The electrical isolation controller 102 applies flows of electrical power to the refuse collecting body 108. The electrical isolation controller 102 detects a refuse collecting body 108 resistance. The electrical isolation controller 102 compares the detected combined chassis 106 and refuse collecting body 108 resistance to a combined chassis 106 and refuse collecting body 108 threshold resistance. At 718, the combined chassis 106 and refuse collecting body 108 isolation test is completed. At 718, the process may wait for completion of the isolation test with the body 108 connected. In the event that an isolation fault is detected, the location of the issue can be determined (i.e., either between body 108 or the chassis 106.

At 720, the results of the combined chassis 106 and refuse collecting body 108 resistance passed to the controller 150. The results are passed from the electrical isolation controller 102 along the controller area network 400 to the controller 150.

At 722, when the detected combined chassis 106 and refuse collecting body 108 resistance is greater than or equal to the combined chassis 106 and refuse collecting body 108 threshold resistance, the electrical isolation controller 102 determines that no shorts or ground faults exist in the combined chassis 106 and refuse collecting body 108 and at 724 signal representing a PASS condition is generated. The process proceeds to 726, where the signal representing the PASS condition from the electrical isolation controller 102 is received at the controller 150. The controller 150 enables operation of the refuse collecting body 108.

Returning to 722, when the detected combined chassis 106 and refuse collecting body 108 resistance is less than the combined chassis 106 and refuse collecting body 108 threshold resistance, the electrical isolation controller 102 determines that a short or ground fault exists in the combined chassis 106 and refuse collecting body 108, and at 728, a signal representing a FAIL condition signal is generated and sent from the electrical isolation controller 102 to the controller 150. At 730, the signal representing the FAIL condition signal is received at the controller 150. The controller 150 electrically disables the refuse collecting body 108 by sending a command signal to the connector 158 to open, disconnecting the electrical storage device 160 from the DC-DC converter 166a. The body controller 150 can perform further troubleshooting and diagnostics on the refuse collecting body 108.

FIG. 8 shows a power-up sequence 800 for the refuse collection vehicle 100 performed over the controller area network 400. During the power-up sequence 800, the chassis 106 pre-charge process is completed by connecting the high voltage side of the electrical storage device 160 in the chassis 106 to the high voltage side of the DC-DC converter 166a. The DC-DC converter output is delayed for between approximately 30-60 seconds, allowing the chassis 106 to perform its normal chassis isolation test. The electrical isolation controller 102 determines a pass or fail of the chassis isolation test based on comparison of the measured and acceptable resistance values. Upon a failure, the electrical isolation controller 102 via the controller 150 electrically disconnects the refuse collecting body 108 from the chassis 106 and indicates an Isolation Fault on the cab 104 HMI/Display, such as the vehicle instruments 412.

At 802, the refuse collection vehicle 100 start sequence begins. The operator turns the key ignition from the OFF position to the ON position. A signal is transmitted from the ignition to the controller 150 on the controller area network 400 based on the position of the key in the ignition. When the key moves from the OFF position to the ON position, a signal representing a Chassis Ignition Key =ON condition is transmitted to the controller 150, signifying the operator has moved the key in the ignition to the ON position. The controller 150 receives the signal representing a Chassis Ignition Key=ON condition. The operator also places or ensures a Cab 104 Emergency Stop switch (Cab E-Stop) is in a reset position, and not a tripped position. A signal is transmitted from the Cab E-Stop to the controller 150 on the controller area network 400 based on the position of the Cab E-Stop. When the Cab E-Stop is in the reset position, a signal representing a Cab E-Stop=RESET condition is transmitted to the controller 150, signifying the Cab E-Stop is reset. The controller 150 receives the signal representing the Cab E-Stop=RESET condition. When both these conditions are met, the process proceeds to step 804.

At step 804, a first time delay is initiated. In this implementation, time period of the first time delay is five seconds. In other implementations, the first time delay can be any suitable time period. After the first time delay, the process proceeds to step 806.

At 806, the controller 150 waits for a ready signal from the DC-DC converter 166a. After the controller 150 receives the ready signal from the DC-DC converter 166a, the process continues at step 810. When the controller 150 does not receive the ready signal from the DC-DC converter 166a after a pre-determined time period, the process does not continue, and an error message is sent to the operator.

At 810, the controller 150 transmits preliminary settings to the DC-DC converter 166a. After the controller 150 has transmitted the preliminary settings to the DC-DC converter 166a, the process proceeds to step 812.

At 812, the controller 150 waits for a high voltage connect command signal from the chassis 106. The controller 150 monitors for the high voltage connect command signal.

The refuse collecting body 108 remains electrically isolated from the chassis electrical power system 146, keeping contactors 510, 512, 514 open until receipt of a close contactor command signal from the chassis 106. Receipt of the close contactor command signal will begin closing of contactors starting the RCV pre-charge sequence. Receipt of the open contactor command signal will immediately begin a controlled shutdown described in reference to FIG. 9, opening the contactors 810, 512, 514, and disconnecting the refuse collecting body 108 from the chassis electrical power system 146. There are no timed warnings transmitted to the operator before the power-down sequence described in FIG. 9 when the open contactor command signal is received in step 812. The results are displayed on the refuse body human machine interface 422. When the controller 150 receives the close contactor command signal, the process continues to step 814.

At 814, the controller 150 closes the negative contactor 514. The controller 150 transmits a command signal via the controller area network 400 to the connector 158 to shut the negative contactor 514. The controller 150 monitors, via the controller area network 400, the position of the negative contactor 514. For example, sensor which can sense the position of the 514 can be coupled to the negative contactor 514 and the controller 150 can query the sensors to determine the position of the 514. Or, when the negative contactor 514 changes position, the sensors can transmit a signal representing the position of the negative contactor 514 to the controller 150.

At 816, when the controller 150 determines the position of the negative contactor 514. At 818, when the controller 150 determines the negative contactor 514 is not closed (open or an NO condition), the process 800 proceeds to step 900 to shut down any open contactors 510, 512, 514, securing power to the DC-DC converter 166a as described in reference to FIG. 9. At 820, when the controller 150 determines the negative contactor 514 is closed (a YES condition), the process proceeds to step 822.

At 822, the controller 150 transmits a control signal to the pre-charge circuit 500 to close the pre-charge contactor 510. The controller 150 monitors the connector 158 engagement status and transmits a refuse body electrical power subsystem 148 engagement status which signifies an engaged status when the DC-DC converters 166a, 166b are connected to the chassis electrical power system 146. The controller 150 maintains power to the refuse body electrical power subsystem 148 until the controller 150 indicates a disengaged status via this signal. This allows opportunity for refuse collecting body 108 to stow to transit position before loss of power. The connector 158 opens, electrically disconnecting the refuse collecting body 108 from the chassis 106 within a maximum of 90 seconds as described in reference to FIG. 9. The process proceeds to step 824. At 824, the controller 150 waits for a signal from the electrical isolation controller 102 signifying the position of the pre-charge contactor 510. At 826, when the controller 150 determines the pre-charge contactor 510 is not closed (open or an NO condition), the process 800 proceeds to step 900 to shut down any open contactors 510, 512, 514, securing power to the DC-DC converter 166a as described in reference to FIG. 9. At 828, when the controller 150 determines the 510 is closed (a YES condition), the process proceeds to step 830.

At 830, two independent steps occur while the controller 150 waits for the DC-DC Converter Pre-Charge signal from the electrical isolation controller 102 while the pre-charge completes. First, at 832, an HV Pre-Charge Timeout Elapsed Timer starts. In this example, the time period of the HV Pre-Charge Timeout Elapsed Timer is four seconds. In other implementations, any suitable time period for the HV Pre-Charge Timeout Elapsed Timer may be used. When the time period of the HV Pre-Charge Timeout Elapsed Timer equals or exceeds four seconds, an error condition occurs and the process continues to step 834, and on to step 900 to shut down any open contactors 510, 512, 514, securing power to the DC-DC converter 166a as described in reference to FIG. 9. Simultaneously, at 836, the controller 150 waits for a HV Pre-Charge complete signal from the electrical isolation controller 102. The electrical isolation controller 102 monitors the DC-DC converter 166a voltage. When the DC-DC converter 166a input voltage is greater than or equal to a DC-DC converter 166a input voltage threshold, the electrical isolation controller 102 transmits a signal to the controller 150 signifying the DC-DC converter 166a has reached a minimum voltage for operations which results in a continuation of the process to step 838. The DC/DC converter 166a measures the input voltage and transmits the input voltage to the electrical isolation controller 102 and on to the body controller 150. In this implementation, the DC-DC converter 166a input voltage threshold is ninety percent of the electrical storage device 160 voltage. In other implementations, any suitable percentage of electrical storage device 160 voltage may be used.

At 838, the controller 150 has received the signal signifying the DC-DC converter 166a has reached the minimum voltage for operations. Responsive to receiving the signal signifying the DC-DC converter 166a has reached the minimum voltage for operations, the controller 150 transmits a command signal to the 102 to close the positive contactor 512. The process continues to step 840.

At 840, the electrical isolation controller 102 monitors the position of the positive contactor 512. At 842, when the electrical isolation controller 102 detects that the positive contactor 512 did not close despite the command signal to close being transmitted, the electrical isolation controller 102 transmits a signal to the controller 150 indicating that the positive contactor 512 did not close. When the controller 150 receives the signal indicating that the positive contactor did not close, the process proceeds to step 900 to shut down any open contactors 510, 512, 514, securing power to the DC-DC converter 166a as described in reference to FIG. 9. At 844, when the electrical isolation controller 102 that the positive contactor 512 did close, the electrical isolation controller 102 transmits a signal to the controller 150 indicating that the positive contactor 512 closed: a YES condition. The process continues to step 846.

At 846, the controller 150 receives the signal indicating that the positive contactor 512 closed from the electrical isolation controller 102. Responsive to receiving the signal from the electrical isolation controller 102 indicating that the positive contactor 512 is closed, the controller 150 transmits a command signal to the electrical isolation controller 102 to open the pre-charge contactor 510. The process continues to step 848.

At 848, the refuse collecting body 108 ground fault isolation tests are performed. First, at 850, the electrical isolation controller 102 determines whether less than twelve hours has passed since the last Chassis Ignition Key =ON condition. At 852, the electrical isolation controller 102 compares the current time to the last time the key was in the ON position. This check is based on the assumption that the last time the refuse collection vehicle 100 was operated, there were no ground faults on the refuse collection vehicle 100 and the time period from last operation was small enough that no maintenance was performed, or equipment failures occurred while the refuse collection vehicle 100 was shutdown. In this implementation, twelve hour is used, but in other implementations, any suitable time period may be used. At 850, when the electrical isolation controller 102 determines that the elapsed time period from the last time the refuse collection vehicle 100 was operated is equal to or greater than twelve hours, the electrical isolation controller 102 transmits a signal to the controller 150 indicating that it has been equal to or more than twelve hours (an NO condition). When the controller 150 receives the signal indicating that it has been twelve or more hours since the last operation, the process proceeds to step 854 the chassis isolation test is performed. For example, the electrical isolation controller 102 and the controller 150 perform the operations 700 described in reference to FIG. 7, specifically, steps 704 to 730. The process proceeds to step 856.

At 856, the electrical isolation controller 102 determines whether an isolation fault exists. The electrical isolation controller 102 compares the resistance of chassis 106 and the refuse collecting body 108 to the threshold resistance of the chassis 106 and the refuse collecting body 108, respectively, as described in reference to FIG. 7. When the resistance of either the chassis 106 and the refuse collecting body 108, or the combined chassis 106 and refuse collecting body 108 is less than the threshold resistance, at step 868, i.e., a NO condition, the electrical isolation controller 102 transmits a signal representing the NO condition to the controller 150 and the process proceeds to step 900 to shut down any open contactors 510, 512, 514, securing power to the DC-DC converter 166a as described in reference to FIG. 9. At 860, when the electrical isolation controller 102 determines the resistance of both the chassis 106 and the refuse collecting body 108, and the combined chassis 106 and refuse collecting body 108 is equal to or greater than the threshold resistance, a YES condition, the electrical isolation controller 102 transmits a signal representing the YES condition to the controller 150 and the process proceeds to step that the positive contactor 512 did close, the electrical isolation controller 102 transmits a signal to the controller 150 indicating that the positive contactor 512 closed: a YES condition. The process proceeds to step 862. Returning to step 850, when the electrical isolation controller 102 determines that the elapsed time period from the last time the refuse collection vehicle 100 was operated is less than twelve hours, the electrical isolation controller 102 transmits a signal to the controller 150 indicating that it has been less than twelve hours, at step 864 (i.e., a YES condition). When the controller 150 receives the signal indicating that it has been less than twelve hours since the last operation, the process proceeds from step 864 to step 862.

At 862, the controller 150 transmits a RUN command to the DC-DC converter 166a. The process continues to step 866. At step 866, the process split into a group 868 of three functions 870, 872, and 874 which are performed simultaneously while the controller 150 waits for the DC-DC converter 166a low voltage Pre-Charge operational test and warmup. At 870, the controller 150 monitors the DC-DC converter 166a low voltage pre-charge circuit for a timeout condition. When the elapsed time exceeds one and a half seconds, the process proceeds to step 900 to shut down any open contactors 510, 512, 514, securing power to the DC-DC converter 166a as described in reference to FIG. 9. At 872, the controller 150 monitors the DC-DC converter 166a low voltage pre-charge circuit for an output voltage deviation error. When the output voltage deviates more than 5% from the linear curve, an error signal is outputted and the process proceeds to step 900 to shut down any open contactors 510, 512, 514 and secure power to the DC-DC converter 166a as described in reference to FIG. 9. At 874, the controller 150 monitors the DC-DC converter 166a low voltage output voltage to reach a minimum low voltage operating threshold. When the low voltage output voltage is greater than the minimum low voltage operating voltage threshold, the process proceeds to step 876.

At 876, the controller 150 transmits operational settings to the DC-DC converter 166a. After the DC-DC converter 166a is performing at the operational settings, the process proceeds to step 878. At 878, the refuse collection vehicle 100 is ready for operation.

FIG. 9 is a flow chart of a power-down sequence 900. Sometimes, such as when the chassis 106 and/or the refuse collecting body 108 fails the ground fault isolation test, the controller 150 electrically disconnects the refuse collecting body 108 from the chassis 106 by opening the connector 158. The refuse collection vehicle 100 performs the following functions for the Electric Vehicle (EV) Truck chassis to RCV Power-Down Request command. Receipt of an execute normal power-down signal will result in a 60 second timed warning giving opportunity for refuse body mechanisms to stow to transit position before a loss of power. Receipt of an execute emergency power-down signal will result in an immediately controlled shutdown, opening the connector 158 (any and all contactors 510, 512, 514 will be opened), thus electrically disconnecting the refuse collecting body 108 from the electrical storage device 160. There is no timed warning before an emergency power-down. The type of failure determines whether a normal or emergency power-down is performed. The power-down sequence 900 can begin at step 902, 904, or 906 based the type of power-down commanded. The power-down sequences beginning at step 902 will be described first. At 902, the controller 150 transmits an open contactor command signal to the connector 158. The power-down process proceeds to step 908. At step 908, the refuse collecting body 108 begins an immediate shutdown. The process proceeds to step 910.

At 910, the refuse collecting body 108 control display in the cab 104 displays an alert to the operator signifying an immediate power-down. For example, the alert can include one or more of an audible alarm, a flashing light, a vibration, or a diagnostic message on the refuse body human machine interface 422 and/or the display 156. The process proceeds to step 912.

At 912, the controller 150 monitors the DC-DC converter 166a output until the voltage output is zero and the current output is zero. The process continues to step 914.

At 914, the controller 150 monitors the low voltage DC-DC converter until the current amps are greater than negative 10 and the amps are less than 10 checking that the DC/DC converter 166a has dissipated its stored energy. When these conditions are met, the process continues to step 916.

At 916, the controller 150 transmits a command signal to the connector 158 to open the positive contactor 512. The process proceeds to step 918.

At 918, the controller 150 waits one second, and transmits a command signal to the connector 158 to open the negative contactor 514. In other implementations, any suitable time delay may be used. This time delay allows any residual power to dissipate on ground before disconnecting the high voltage ground from the DC/DC converter 166a. The process continues to step 920. The controller 150 monitors the contactors to verify the contactors have moved with monitoring contacts to determine their state.

At 920, all the contactors 510, 512, and 514 are open, the refuse collecting body 108 electrically disconnected from the electrical storage device 160, and the refuse collecting body 108 power-down sequence is complete.

In some cases, the power-down sequence begins at step 904. Beginning at step 904 is an emergency power-down sequence. At 904, the controller 150 commands an emergency power-down. Next, the emergency power-down sequence proceeds to step 908, rejoining the power-down process 900.

In some cases, the power-down sequence begins at step 906. Beginning at step 906 is a normal power-down sequence. At 906, the controller 150 commands an emergency power-down. Next, the normal power-down sequence proceeds to step 922.

At 922, the process begins a controlled shutdown. The process continues to step 924.

At 924, the refuse collecting body 108 control display in the cab 104 displays a sixty-second alert to the operator signifying a power-down request and instructing the operator to stow the lift 122. The process proceeds to 926.

At 926, the controller 150 waits for sixty seconds to allow the operator to stow all of the refuse handling mechanisms. The process proceeds to step 912 and continues the power-down sequence until step 920 when refuse collecting body 108 power-down is complete.

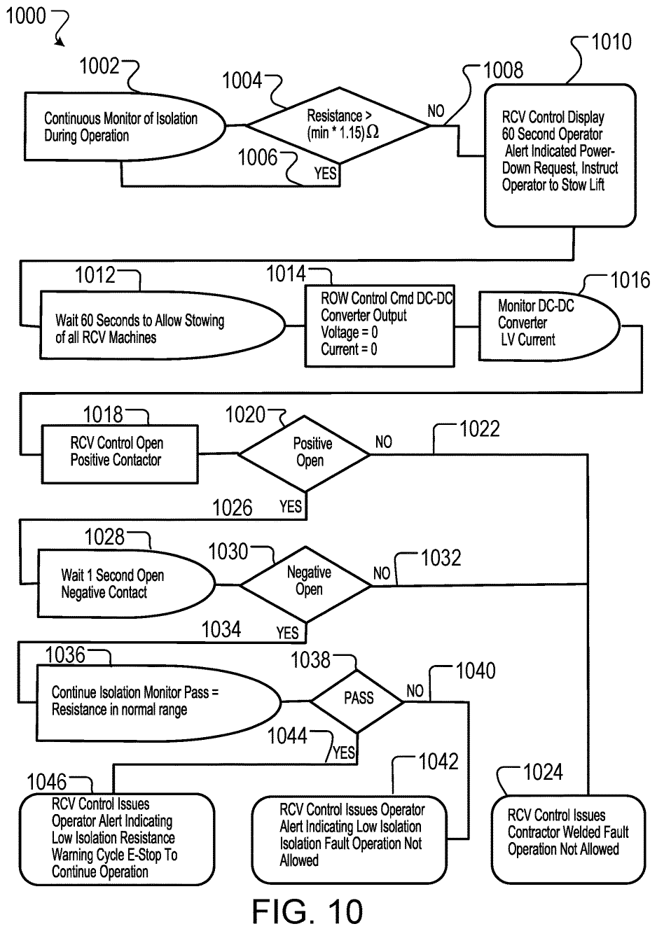

FIG. 10 is a flow chart of a runtime isolation test sequence 1000. In some implementations, the electrical isolation controller 102 performs the runtime isolation test sequence 1000 during operation of the refuse collection vehicle 100 while the chassis 106 and the refuse collecting body 108 are electrically connected.

The electrical isolation controller 102 constantly monitors the combined chassis 106 and the refuse collecting body 108 for a drop in isolation resistance. Responsive to the isolation resistance dropping below 115% of acceptable value, the electrical isolation controller 102 issues a timed alert to the operator, instructing the operator to stow of all of the refuse handling mechanisms of the refuse collecting body 108 for safe transit. Once the time limit has expired, the electrical isolation controller 102 will disable the refuse collecting body 108 electrically and subsequent disconnect from the electrical storage device 160 on the chassis 106. Once the refuse body electrical power subsystem 148 is disconnected from the chassis electrical power system 146, the electrical isolation controller 102 will continue monitoring the isolation resistance to determine whether the low resistance is on the refuse collecting body 108 or the chassis 106.

The controller area network 400 uses PGNs and SPNs to provide the refuse collecting body 108 electrical isolation controller 102 the capability of monitoring for ground faults when the chassis 106 is performing an isolation test and to provide the electrical isolation controller 102 capability of detecting a drop in isolation resistance and formulating a response.

The runtime isolation test sequence 1000 begins at step 1002. At 1002, the electrical isolation controller 102 performs a continuous monitor of isolation during operation of the refuse collection vehicle 100. At 1004, the electrical isolation controller 102 compares the resistance to a minimum threshold resistance. In this operation the resistance of the combined chassis 106 and refuse collecting body 108 during operation is a minimum allowable resistance in ohms times 1.15. At 1006, when the resistance of the combined chassis 106 and refuse collecting body 108 during operation is greater than the minimum threshold resistance, a YES condition exists and the process returns to step 1002, continuously monitoring the resistance of the combined chassis 106 and refuse collecting body 108 for ground faults. At 1008, when the resistance of the combined chassis 106 and refuse collecting body 108 during operation is less than the minimum threshold resistance, a NO condition is generated, and the process moves to step 1010.

At step 1010, the refuse collecting body 108 control display in the cab 104 displays a sixty-second alert to the operator signifying a power-down request and instructing the operator to stow the lift 122. A countdown timer can be displayed to the operator. The process proceeds to 1012.

At 1012, the controller 150 waits for sixty seconds to allow the operator to stow all of the refuse handling mechanisms. The process proceeds to step 1014.

At 1014, the controller 150 monitors the DC-DC converter 166a output until the voltage output is zero and the current output is zero. The process continues to step 1016.

At 1016, the controller 150 monitors the low side of the voltage DC-DC converter 166a. When these conditions are met, the process continues to step 916. The process continues to step 1018.

At 1018, the controller 150 transmits a command signal to the connector 158 to open the positive contactor 512. The process proceeds to step 1020.

At 1020, controller 150 monitors the positive contactor 512 position. At 1022, when the positive contactor 512 fails to open: a NO condition exists, the process proceeds to step 1024. At 1024, the controller 150 transmits a signal to the operator signifying a refuse collecting body 108 control issues “CONTACTOR WELDED FAULT” and operation of the refuse collecting body 108 is not allowed. Returning to step 1020, at 1026, when the positive contactor 512 opens—a YES condition—the process continues to step 1028.

At 1028, the controller 150 waits one second, and transmits a command signal to the connector 158 to open the negative contactor 514. In other implementations, any suitable time delay may be used. The process continues to step 1030.

At 1030, the monitors the negative contactor 514 position. At 1032, when the negative contactor 514 fails to open: a NO condition exists, the process proceeds to step 1024. At 1024, the controller 150 transmits a signal to the operator signifying a refuse collecting body 108 control issues “CONTACTOR WELDED FAULT” and operation of the refuse collecting body 108 is not allowed. Returning to step 1030, at 1034, when the negative contactor 514, i.e., a YES condition, the refuse collecting body 108 is electrically disconnected from the chassis 106. Operation of the refuse collecting body 108 is disabled. The chassis 106 can still be operated. The process continues to step 1036.

At 1036, the controller 150 the electrical isolation controller 102 continues monitoring resistance of the refuse collecting body 108. A pass condition occurs when the resistance of the refuse collecting body 108 is within a normal range based on the type of systems being connected. The process proceeds to step 1038. At step 1038, the electrical isolation controller 102 determines whether the pass condition occurs. At 1040, when the pass condition does not occur, that is, the resistance of the refuse collecting body 108 is not within a normal range, the electrical isolation controller 102 generates a NO condition. The process continues to step 1042. At 1042, the controller 150 transmits an alert signal to the operator signifying a refuse collecting body 108 control issues “ISOLATION FAULT” and operation of the refuse collecting body 108 is not allowed. Returning to step 1038, when the pass condition occurs, that is, the resistance of the refuse collecting body 108 is within the normal range, at 1044, the electrical isolation controller 102 generates a YES condition. The process continues to step 1046. At 1046, the controller 150 transmits an alert signal to the operator signifying “LOW ISOLATION RESISTANCE WARNING-CYLE E-STOP TO CONTINUE OPERATION” and operation of the refuse collecting body 108 can be resumed at the operator discretion.

A number of embodiments have been described. Nevertheless, it will be understood that various modifications may be made without departing from the spirit and scope of the disclosure. Accordingly, other embodiments are within the scope of the following claim(s).

In other implementations, the electrical isolation controller 102 is positioned on the chassis 106, for example, in the cab 104.

Although the vehicle 100 described above is a refuse collection vehicle which can be referred to as a “garbage truck” that collects refuse or garbage, in some embodiments, such a vehicle is designed to collect a variety of different types of used or discarded refuse materials such as recyclables, hazardous materials, and construction materials.

As another example, although the cab of the refuse vehicle 100 is described above as featuring a compartment for a human driver, in some embodiments, the refuse vehicle can be operated autonomously or semi-autonomously, or a combination thereof.

As yet another example, some embodiments of this disclosure can be implemented without a mobile vehicle chassis. For instance, the storage container and packer can be fixed in place on a ground surface.

As yet another example, although the refuse vehicle is described above as having a side-loading lift, in some embodiments, the refuse vehicle may have a front-loading lift, and/or a rear-loading lift, or no lift at all.

As yet another example, although the service event described above includes certain specific operations of an automated dump cycle, the concept of a “service event” is more broadly understood and used in this disclosure. For instance, in some embodiments, a service event may include a dump cycle including different operations or the same operations performed in a different order (or simultaneously). Additionally, in some embodiments, a service event may include some other manner of depositing waste (or other materials) onto the vehicle. For instance, a service event may include a human worker (or customer) placing the waste into a receptacle of the vehicle.

As yet another example, although the packer described above features an auger-style compactor, in some embodiments, the packer may include a translating packer blade. The auger-style compactor or the translating packer blade can be powered by the refuse body electrical power subsystem through the chassis electrical power system by the electric drive featuring an electric motor.

As yet another example, in addition to the above-described sensors for monitoring the lift, packer, and ejector, the refuse vehicle may further include sensors for monitoring a variety of other components, operations, and/or the vehicle's surrounding environment. Such sensors may take a variety of forms. For example, the sensors can include, but are not limited to, an analog sensor, a digital sensor, a CAN bus sensor, a magneto strictive sensor, a radio detection and ranging (RADAR) sensor, a light detection and ranging (LiDAR) sensor, a laser sensor, an ultrasonic sensor, an infrared (IR) sensor, a stereo camera, a three-dimensional (3D) camera, or a combination thereof.

As yet another example, the communicative coupling between the above-described logical controller (e.g., controller 150) and the auger/packer drive and the lift drive may take a variety of forms. For instance, in some embodiments, the logical controller provides command instructions to the drive, and those instructions trigger the drive to regulate the operation of the packer or the lift. Alternatively, in some embodiments, the logical controller provides command instructions to an energy source or intermediate controller—e.g., a battery pack, a converter (battery controller), or a hydraulic pump or valve)—that powers and regulates the drive.

As yet another example, although the logical controller (e.g., controller 150) is described above as issuing control instructions/commands based on determinations that stem from hopper condition data and/or packer load data, in some embodiments, the controller may be operable to issue such instructions/commands in response to user input and/or requests from a remote computing device.

As yet another example, in some embodiments, the above-described refuse collection vehicle is an all-electric vehicle or a partially electric vehicle. For instance, one or more (e.g., all) motive power elements, body controls, and sub-systems of the refuse collection vehicle can be electrically powered by onboard battery packs.

As yet another example, although the information network is described above as an onboard wired data bus, in some embodiments, the network may take the form of a wireless network.

As yet another example, in some embodiments, the above-described intake sensor includes an array of multiple sensors. In some embodiments, the intake sensor array may include multiple varied sensors. In some embodiments, different sensors in the sensory array are mounted in different locations with unique detection directions for monitoring different portions of the refuse intake volume.

As yet another example, although the logical controller (e.g., controller 150) is described and illustrated above as operating the packer and lift, in some embodiments, the logical controller may be integrated with one or more other onboard computing devices that control different assemblies or systems of the vehicle chassis or refuse collecting body (e.g., the ejector, lift, tailgate, and so forth). As yet another example, although the logical controller is described and illustrated above as an onboard component, in some embodiments, the controller may be implemented such that one or more of its processing or storage components reside at a remote location.

As yet another example, some embodiments may further include associating the detection of an anomaly affecting the packer with a particular service event and/or location. In such instances, the refuse collection vehicle can include location sensor device(s), such as GPS receivers or other types of sensors that enable location determination. The location sensor(s) can generate location data that describes the current location of the vehicle. Accordingly, when an electrical fault is detected, it can be associated and logged with the current location of the vehicle at that time. Doing so facilitates the ability to determine which customer service event may have been the source of the anomaly.

As yet another example, although the above-discussed embodiments describe aggregating electrical fault data values from multiple duty intervals in terms of calculating a rolling sum, in some embodiments, the aggregating process includes calculating a rolling mean/median/mode and/or performing other known data processing techniques. For instance, the aggregating process may include clustering operations—e.g., identifying a certain number of consecutive values above or below a given threshold.

As yet another example, although the above-discussed embodiments describe comparing electrical fault data values from multiple duty intervals to empirically derived static thresholds, in some embodiments, the thresholds are dynamically derived or adjusted over time (e.g., during a refuse collection route or between routes). Additionally, in some embodiments, the thresholds are determined using heuristic and/or machine learning, and/or artificial intelligence techniques.

While this specification contains many specifics, these should not be construed as limitations on the scope of the disclosure or of what may be claimed, but rather as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some examples be excised from the combination, and the claimed combination may be directed to a sub-combination or variation of a sub-combination.

1. A refuse collection vehicle, comprising:
a vehicle chassis comprising:
a chassis electrical power system; and
a vehicle controller operatively coupled to the chassis electrical power system;
a refuse body physically mounted on the vehicle chassis, the refuse body comprising a refuse body electrical power subsystem;
a connector disposed between the chassis electrical power system and the refuse body electrical power subsystem, the connector operable to electrically connect and disconnect the chassis electrical power system and the refuse body electrical power subsystem; and
a controller operatively coupled to the connector, the controller configured to perform operations comprising:
performing a first electrical isolation test of the chassis electrical power system while the refuse body electrical power subsystem is disconnected from the chassis electrical power system;
sending a signal to the vehicle controller indicating a result of the first electrical isolation test;
in response to the signal indicating an acceptable result of the first electrical isolation test, electrically connecting the refuse body electrical power subsystem to the chassis electrical power system; and
performing a second electrical isolation test of the chassis electrical power system with the refuse body electrical power subsystem connected.

2. The refuse collection vehicle of claim 1, wherein the controller is positioned on the refuse body.

3. The refuse collection vehicle of claim 1, wherein the refuse body electrical power subsystem comprises a DC/DC converter configured to power a refuse handling component of the refuse body, the DC/DC converter optionally coupled to the refuse body electrical power subsystem by the connector.

4. The refuse collection vehicle of claim 3, wherein the refuse handling component comprises at least one of:
a lift arm configured to reposition a customer refuse container relative to the refuse body, the lift arm powered by the DC/DC converter, or
a packer configured to reposition customer refuse within the refuse body, the packer powered by the DC/DC converter.

5. The refuse collection vehicle of claim 1, further comprising a controller area network coupled to the chassis electrical power system, the refuse body electrical power subsystem, the connector, and the controller.

6. The refuse collection vehicle of claim 1, wherein performing the first electrical isolation test of the chassis electrical power system comprises:
commencing the first electrical isolation test responsive to a chassis ignition key transitioning to an ON state;
determining a resistance of the chassis electrical power system;
comparing the resistance of the chassis electrical power system to a threshold resistance for the chassis electrical power system; and
based on the resistance of the chassis electrical power system greater than or equal to the threshold resistance, generating the signal indicating the acceptable result of the first electrical isolation test.

7. The refuse collection vehicle of claim 1, wherein the controller is further configured to perform operations comprising:
bypassing performing the first electrical isolation test of the chassis electrical power system when a time interval since operation of the refuse collection vehicle is less than a threshold time interval.

8. The refuse collection vehicle of claim 7, wherein the threshold time interval is twelve hours.

9. The refuse collection vehicle of claim 1, wherein the controller is further configured to perform operations comprising:
in response to the signal indicating an unacceptable result of the first electrical isolation test, shutting down the refuse body electrical power subsystem.

10. The refuse collection vehicle of claim 9, wherein the controller is further configured to perform operations comprising:
generating a user alert signal indicating the unacceptable result of the first electrical isolation test; and
transmitting the user alert signal to a user accessible device.

11. The refuse collection vehicle of claim 1, wherein the controller is further configured to perform operations comprising:
after performing the second electrical isolation test of the chassis electrical power system with the refuse body electrical power subsystem connected, sending the signal to the controller of the refuse body electrical power subsystem indicating the result of the second electrical isolation test; and
in response to the signal indicating the acceptable result of the second electrical isolation test, enabling operation of the chassis electrical power system with the refuse body electrical power subsystem.

12. The refuse collection vehicle of claim 11, wherein the controller is further configured to perform operations comprising:
in response to the signal indicating an unacceptable result of the second electrical isolation test, electrically disconnecting the refuse body electrical power subsystem from the chassis electrical power system; and
responsive electrically disconnecting the refuse body electrical power subsystem from the chassis electrical power system, disabling operation of the refuse body electrical power subsystem.

13. The refuse collection vehicle of claim 11, wherein the controller is further configured to perform operations comprising:
during operation of the chassis electrical power system with the refuse body electrical power subsystem, performing a continuous electrical isolation test of the chassis electrical power system with the refuse body electrical power subsystem;
sending the signal to the controller of the refuse body electrical power subsystem indicating the result of the first electrical isolation test; and
in response to the signal indicating an acceptable result of the continuous electrical isolation test, maintaining the refuse body electrical power subsystem electrically connected to the chassis electrical power system.

14. The refuse collection vehicle of claim 13, wherein performing the continuous electrical isolation test of the chassis electrical power system with the refuse body electrical power subsystem comprises:
comparing a resistance of the electrically connected chassis electrical power system and the refuse body electrical power subsystem to a threshold resistance for the electrically connected chassis electrical power system and the refuse body electrical power subsystem; and
based on the resistance of the electrically connected chassis electrical power system and the refuse body electrical power subsystem greater than or equal to the threshold resistance for the electrically connected chassis electrical power system and the refuse body electrical power subsystem, generating the signal indicating an acceptable result of the continuous electrical isolation test.

15. The refuse collection vehicle of claim 14, wherein the controller is further configured to perform operations comprising:
after performing the continuous electrical isolation test of the chassis electrical power system with the refuse body electrical power subsystem connected, sending a signal to the controller of the refuse body electrical power subsystem indicating a result of the continuous electrical isolation test; and
in response to the signal indicating an acceptable result of the continuous electrical isolation test, maintaining operation of the chassis electrical power system with the refuse body electrical power subsystem enabled.

16. The refuse collection vehicle of claim 15, wherein the controller is further configured to perform operations comprising:
in response to the signal indicating an unacceptable result of the continuous electrical isolation test, disconnecting the refuse body electrical power subsystem from the chassis electrical power system.

17. The refuse collection vehicle of claim 16, wherein the controller is further configured to perform operations comprising:
in response to the signal indicating an unacceptable result of the continuous electrical isolation test, generating a user alert signal indicating the unacceptable result of the first electrical isolation test; and
transmitting the user alert signal to a user accessible device.

18. The refuse collection vehicle of claim 17, wherein the controller is further configured to perform operations comprising:
after disconnecting the refuse body electrical power subsystem from the chassis electrical power system, performing the first electrical isolation test on the chassis electrical power system.

19. A controller for an electrically powered refuse collection vehicle, the controller configured to perform operations comprising:
performing a first electrical isolation test of a chassis electrical power system of the electrically powered refuse collection vehicle while a refuse body electrical power subsystem of the electrically powered refuse collection vehicle is disconnected from the chassis electrical power system;
sending a signal to a vehicle controller of the electrically powered refuse collection vehicle indicating a result of the first electrical isolation test;
in response to the signal indicating an acceptable result of the first electrical isolation test, electrically connecting the refuse body electrical power subsystem to the chassis electrical power system; and
performing a second electrical isolation test of the chassis electrical power system with the refuse body electrical power subsystem connected.

20. A method of confirming electrical isolation status of an electrical circuit of an electrically powered vehicle, the method comprising:
performing a first electrical isolation test of a chassis electrical power system of the electrical circuit while a body electrical power subsystem of the electrical circuit is disconnected from the chassis electrical power system;
sending a signal to a controller of the body electrical power subsystem indicating a result of the first electrical isolation test;
in response to the signal indicating an acceptable result of the first electrical isolation test, electrically connecting the body electrical power subsystem to the chassis electrical power system; and
performing a second electrical isolation test of the chassis electrical power system with the body electrical power subsystem connected.
